(19) United States
(12) Patent Application Publication
(10) Pub. No.: US 2012/0156330 A1
(43) Pub. Date: Jun. 21, 2012

(54) LOW SODIUM MARGARINE SPREAD ENRICHED WITH PROBIOTICS FIELD

(76) Inventors: Dilip K. Nakhasi, Bourbonnais, IL (US); Danielle Corbin, Richton Park, IL (US)

(21) Appl. No.: 12/970,862

(22) Filed: Dec. 16, 2010

(51) Int. Cl. A23L 1/29

(52) U.S. Cl. 426/61

(57) ABSTRACT

Described herein are shelf stable low sodium compositions having reduced levels of trans fats. The compositions comprise a reduced trans base oil, an unhydrogenated oil, water, a low sodium sea salt, a probiotic and one or more additives. Also provided are methods of preparing such compositions and use thereof.

### FIELD

Provided herein are shelf stable low sodium compositions comprising a probiotic bacterium. The compositions have reduced levels of trans fats. Also provided are methods of preparing such compositions and use thereof.

### BACKGROUND

A variety of relatively hard fat compositions, e.g., margarine, spreads, shortening, and frying fat, are formed from seed oils and vegetable oils. For example, plastic fat compositions such as margarine and low-fat spreads typically comprise an emulsion of an oil phase (typically including a liquid oil and a hard fat, which usually has been hardened by hydrogenation) with an aqueous phase, together with various emulsifiers, stabilizers, preservatives, and flavoring agents.

As a process of hydrogenation, unsaturated fatty acids can be converted from their natural cis configuration to their trans isomer form. Recent studies have indicated that trans-fatty acids may impact cardiovascular health more negatively than saturated fatty acids do. In part due to this recent research, consumers are becoming attentive to the trans-fatty acid content of their diets and many consumers are beginning to prefer products with lower trans-fatty acid content.

As reported in the literature, a diet consistent with high sodium intake augments the risk of cardiac, vascular, renal and cerebral diseases. It is therefore desired that the margarine compositions contain low sodium.

With the increasing interest from consumers in a healthy diet, it is also becoming important to provide different food products which comprise probiotics, such as bacteria, where the products have good longevity of the probiotics.

Thus, there is a need in the art to provide shelf stable low sodium reduced trans fat margarine compositions that comprise probiotics in amounts desirable for health benefits to the consumer but which do not comprise unacceptable, or health endangering, amounts of undesirable pathogens or spoilage yeasts or moulds.

### SUMMARY

In certain embodiments, provided herein are shelf stable compositions comprising a reduced trans base oil, an unhydrogenated oil, water, a low sodium sea salt and probiotics. In certain embodiments, the compositions provided herein have a shelf life of up to 6-8 weeks or more. In certain embodiments, the compositions further comprise additives, including, but not limited to emulsifiers, preservatives, flavoring agents, and coloring agents. In certain embodiments, the compositions are margarine compositions.

In one embodiment, provided herein are methods for producing a shelf stable margarine composition comprising a reduced trans base oil, an unhydrogenated oil, water, a low sodium sea salt and probiotics.

In certain embodiments, the method of preparation comprises the step of providing a composition comprising a reduced trans fat base oil, an unhydrogenated oil, water, low sodium sea salt and one or more additives, mixing the composition, cooling the composition, adding a probiotic, and mixing the composition again.

In certain embodiments, the margarine compositions provided herein have lower levels of saturated fats and trans fats, and sodium. In certain embodiment, the margarine compositions provided herein are used in bakery products, e.g., cookies, cakes, pie crusts, breads and other products in place of conventional margarines.

It is to be understood that both the foregoing general description and the following detailed description are exemplary and explanatory only and are not restrictive.

### BRIEF DESCRIPTION OF DRAWINGS

FIG. 1 provides an exemplary flow diagram showing various steps in the method for preparing compositions described herein.

FIG. 2 demonstrates stability of bifidobacterium in the soft spread of Example 2.

FIG. 3 demonstrates stability of bifidobacterium in the soft spread of Example 9.

FIG. 4 demonstrates stability of bifidobacterium in the soft spread of Example 10.

### DETAILED DESCRIPTION

Provided herein are margarine compositions comprising reduced trans base oil, an unhydrogenated oil, water, a low sodium sea salt and probiotics. Further provided are methods of making the compositions and uses of the compositions. The methods and compositions are described in detail in the sections below.

### DEFINITIONS

Unless defined otherwise, all technical and scientific terms used herein have the same meaning as is commonly understood by one of ordinary skill in the art. All patents, applications, published applications and other publications are incorporated by reference in their entirety. In the event that there are a plurality of definitions for a term herein, those in this section prevail unless stated otherwise.

The term “plastic” as used herein is utilized to designate a margarine composition which is solid at room temperature.

The term “fat” as used herein is intended to include all edible, fatty acid triglycerides regardless of origin or whether they are solid or liquid at room temperature. Thus, the term “fat” includes normally liquid and normally solid vegetable and animal fats and oils.

The term “hard fat” or “hydrogenated fat” as used herein refers to fully or partially hydrogenated oil(s), solid stearin fractions, partial esters such as diglycerides and monoglycerides, waxes or mixtures thereof.

The term “oil” as employed herein, is intended to refer to those fats which are liquid in their unmodified state. Natural and synthetic fats and oils are included in these terms.

The terms “edible oil”, “base oil” or “liquid oil” as used herein refer to an oil which is substantially liquid at room temperature. The base oil or liquid oil can be unhydrogenated oil or partially hydrogenated oil, modified oil or mixtures thereof.

The terms “probiotic”, “probiotic bacteria”, or “live (desirable) micro-organisms” as used herein, refer bacteria that are naturally present in the food like yogurt and other fermented foods, and in the gastrointestinal tract of humans and animals. They are beneficial bacteria that enhance the body's defenses against a number of health conditions.

As used herein, “effective amount” refers to an amount necessary to achieve a selected result. For example, an effective amount of a bacteria useful for reducing pathogenic microorganisms in the gastrointestinal tract is an amount that achieves the selected result of reducing the pathogenic microorganisms. Such an amount can be readily determined by one of skill in the art using routine methods.

The term “pathogen” as used herein, refers to micro-organisms which it is not desired to include, or allow to proliferate, in the composition. Examples include micro-organisms known to cause food poisoning.

The term “spoilage yeasts or moulds” as used herein refers to such yeasts or moulds which can cause food spoilage, for example, by gas formation in the product or mould or spore growth on the product surface.

The term “additives” include any additive known for use in a margarine composition, including, for example, emulsifiers, preservatives, flavoring agents, and coloring agents.

It must be noted that, as used in the specification and the appended claims, the singular forms “a,” “an” and “the” include plural referents unless the context clearly dictates otherwise. Thus, for example, reference to “a vegetable oil” includes mixtures of two or more such vegetable oils, and the like. In one embodiment, reference to “a vegetable oil” includes interesterified and/or genetically modified oils.

All percent values are given as weight percent unless expressly stated otherwise.

Compositions

In certain embodiments, provided herein are shelf stable margarine compositions comprising a reduced trans base oil, an unhydrogenated oil, water, a low sodium sea salt, a probiotic and one or more additives. In certain embodiments, the margarine compositions provided herein have a shelf life of up to 6-8 weeks or more. In certain embodiments, the margarine compositions further comprise additives, including, but not limited to emulsifiers, preservatives, flavoring agents, an edible acid and coloring agents.

a) Probiotic Bacteria

The probiotic bacteria for use in the compositions provided herein may be selected from any bacteria desirable to include in food products, including bacteria based on lactic ferments, lactic yeasts or lactic bacteria per say, or based upon a simple of complex mixture of any such ferments, yeasts or bacteria.

In certain embodiments, the bacteria are selected from the following strains: Lactobacillus bulgaricus, Lactobacillus casei, Lactobacillus acidophilus, Lactococcus lactis, Streptococcus thermophilus, Bifidobacterium bifidum, Bifidobacterium lingum and mixtures thereof.

In certain embodiments, the level of probiotic bacteria in the composition is at least about 0.5 billion colony forming units per serving of the composition. In certain embodiments, the level of probiotic bacteria in the composition is about 1 to 15 billion colony forming units per serving of the composition. In certain embodiments, the level of probiotic bacteria in the composition is about 1 to 12, about 1-10, about 1 to 7, about 1 to 5, or 1 to 2 billion colony forming units per serving of the composition. In certain embodiments, the level of probiotic bacteria in the composition is about 1 billion colony forming units per serving of the composition.

b) Low Sodium Sea Salt

In certain embodiments, the composition comprises low sodium sea salt. Any low sodium sea salt known to one of skill in the art can be used in the compositions. Exemplary low sodium sea salt in the compositions include, but are not limited to SOLO® sea salt, NutraSalt®, and low sodium salts described in U.S. Pat. No. 7,621,968; U.S. Pat. No. 7,820,225 and US 2008/0220127.

In certain embodiments, the compositions comprise less sodium than traditional margarines. For example, the compositions can have at least 10% less sodium than traditional margarines, or alternatively at least 20% less sodium, or alternatively at least 30% less sodium, or alternatively at least 40% less sodium, or alternatively at least 50% less sodium, or alternatively at least 60% less sodium, or alternatively at least 70% less sodium, or alternatively at least 80% less sodium, or alternatively as least 90% less sodium than traditional margarines. In another aspect, the compositions can have a range of sodium that is from about 10% to about 90% less sodium than traditional margarines, or alternatively the compositions can have from about 20% to about 90%, or from about 30% to about 90%, or from about 40% to about 90%, or from about 50% to about 90%, or from about 50% to about 80%, or from about 50% to about 70% less sodium than traditional margarines

In certain embodiments, the low sodium sea salt is used in an amount from about 0.5% to about 3% based on the total amount of the margarine composition. In certain embodiments, the low sodium sea salt is used in an amount from about 0.5%-2% or 0.5-1.5% based on the total amount of the margarine composition. In certain embodiments, the low sodium sea salt is used in an amount from about 0.5%, 1%, 1.5% or 2% based on the total amount of the margarine composition.

c) Oil Phase

In certain embodiments, the oil phase in the margarine compositions comprises a reduced trans base oil, an unhydrogenated oil, and a hard fat. Exemplary reduced trans base oils that can be used in the compositions include, but are not limited to, Vream RT, Vreamay RT, and tropical oils made from the fruits of palm trees or variants thereof.

In certain embodiments, the reduced trans base oil is used in an amount ranging from about 20% to about 35% based on the total amount of the margarine composition. In certain embodiments, the reduced trans base oil is used in an amount ranging from about 25% to about 35% based on the total amount of the margarine composition. In certain embodiments, the reduced trans base oil is used in an amount ranging from about 25% to about 30% based on the total amount of the margarine composition. In certain embodiments, the reduced trans base oil is used in an amount of about 20%, 23%, 25%, 27%, 30%, 33% or 35% based on the total amount of the margarine composition.

In certain embodiments, the unhydrogenated oil used herein comprises canola, high oleic canola, soybean, corn, sunflower, rapeseed, peanut, safflower, olive, cottonseed, or a mixture thereof. In certain embodiments, the amount of unhydrogenated oil in the composition is about 20-40% by weight based on the total weight of the composition. In certain embodiments, the amount of unhydrogenated oil in the composition is about 25-35%, or 25-30% by weight based on the total weight of the composition. In certain embodiments, the amount of unhydrogenated oil in the composition is about 25, 27, 29, 30, 32 or 35% by weight based on the total weight of the composition. In certain embodiments, the unhydrogenated oil in the composition is soybean oil.

In certain embodiments, the compositions further comprise a hard fat. In certain embodiments, the hard fat comprises fully or partially hydrogenated oil(s), solid stearin fractions, partial esters such as diglycerides and monoglycerides, waxes or mixtures thereof. In certain embodiments, the fully hydrogenated oil is selected from fully hardened fish oil, fully hardened animal oil, fully hardened palm oil, fully hardened high erucic rape seed oil, fully hardened soya oil, fully hardened sun flower oil, fully hardened corn oil, fully hardened peanut oil, fully hardened safflower oil, fully hardened olive oil, fully hardened palm stearin, fully hardened palm olein, derivatives and mixtures thereof. In certain embodiments, the partially hydrogenated oil is selected from partly hardened fish oil, partly hardened animal oil, partly hardened palm oil, partly hardened high erucic rape seed oil, partly hardened soya oil, partly hardened sun flower oil, partly hardened corn oil, partly hardened peanut oil, partly hardened safflower oil, partly hardened olive oil, partly hardened palm stearin, partly hardened palm olein, partly hardened cotton seed oil, derivatives and mixtures thereof. In certain embodiments, the stearin fraction or the monoglyceride and/or diglyceride can be derived from natural food grade fats, including plant fats, such as coconut oil, palm oil, palm kernel oil, and the like, or fats that have been fully hydrogenated. Thus, in certain embodiments, the stearin fraction or the monoglyceride and/or diglyceride is derived from naturally saturated fats or oils. In certain embodiments, stearin fraction or monoglyceride and/or diglyceride is derived from palm oil.

In certain embodiments, the total amount of hard fat used in the compositions provided herein is from about 0.5 to about 3% by weight based on the total weight of the composition. In certain embodiments, the total amount of hard fat in the compositions is about 0.5%-2.5%, about 0.5%-2%, about 0.5%-1.5% or about 0.5%-1% by weight based on the total weight of the composition. In certain embodiments, the total amount of hard fat in the compositions is about 0.5, 0.7, 1, 1.3, 1.5 or 2% by weight based on the total weight of the composition.

In certain embodiments, the hard fat used herein comprises soybean oil hard fat. In certain embodiments, the amount of soybean oil hard fat in the composition is about 0.5%-3%, about 0.5%-2.5%, about 0.5%-2% or about 0.5%-1.5% by weight based on the total weight of the composition. In certain embodiments, the amount of soybean oil hard fat in the composition is about 0.5, 0.8, 1, 1.5 or 20% by weight based on the total weight of the composition.

In certain embodiments, the composition comprises an edible acid in an amount ranging from about 0.01 to 0.5% by weight based on the total weight of the composition. In certain embodiments, the composition comprises an edible acid in an amount ranging from about 0.01 to 0.3%, 0.01 to 0.1%, or 0.01% to 0.08% by weight based on the total weight of the composition. In certain embodiments, the composition comprises an edible acid in an amount of about 0.01%, 0.3%, 0.05%, 0.07%, 0.1% or 0.2% by weight based on the total weight of the composition. In certain embodiments, the edible acid is acetic acid, citric acid, lactic acid, phosphoric acid, hydrochloric acid, malic acid, tartaric acid, gluconic acid or a mixture thereof. In certain embodiments, the compositions comprise lactic acid in an amount of about 0.01%, 0.3%, 0.05%, 0.07%, 0.1% or 0.2% by weight based on the total weight of the composition.

d) Water

In certain embodiments, the composition comprises water in an amount from about 30-45% by weight based on the total weight of the composition. In certain embodiments, the amount of water in the composition is about 30-40%, or 35-40% by weight based on the total weight of the composition. In certain embodiments, the amount of water in the composition is about 30, 32, 35, 37, 38, 39 or 40% by weight based on the total weight of the composition.

e) Additives

In certain embodiments, the compositions provided herein further comprise one or more additives. Common additives that can be added to the margarine compositions provided herein include, but are not limited to stabilizers, flavoring agents, emulsifiers, anti-spattering agents, colorants, or antioxidants. Exemplary additives are described, for example, in Campbell et al., Food Fats and Oils, 8th Ed., Institute of Margarine and Edible Oils, Washington, D.C.

In certain embodiments, the margarine formulations further comprise an antioxidant. A wide variety of antioxidants are suitable for use, including but not limited to butylated hydroxytoluene (BHT), butylated hydroxyanisole (BHA), tertiary butylhydroquinone (TBHQ), ethylenediaminetetracetic acid (EDTA), gallate esters (i.e. propyl gallate, butyl gallate, octyl gallate, dodecyl gallate, etc.), tocopherols, citric acid, citric acid esters (i.e. isopropyl citrate, etc.), gum guaiac, nordihydroguaiaretic acid (NDGA), thiodipropionic acid, ascorbic acid, ascorbic acid esters (i.e. ascorbyl palmitate, ascorbyl oleate, ascorbyl stearate, etc.) tartaric acid, lecithin, methyl silicone, polymeric antioxidant (Anoxomer) plant (or spice and herb) extracts (i.e. rosemary, sage, oregano, thyme, marjoram, etc.) and mixtures thereof.

In certain embodiments, the margarine formulations further comprise an emulsifier. A wide variety of emulsifiers are suitable for use, including but not limited to mono- and diglycerides, distilled monoglycerides, polyglycerol esters of C₁₂ to C₂₂ fatty acids, propylene glycol mono and diesters of C₁₂ to C₂₂ fatty acids, sucrose mono- and diesters of C₁₄ to C₂₂ fatty acids.

In certain embodiments, the composition comprises cottonseed flakes in an amount from about 2.5-5% by weight based on the total weight of the composition. In certain embodiments, the amount of cottonseed flakes in the composition is about 2.5 to 4.5%, or 3 to 4% by weight based on the total weight of the composition. In certain embodiments, the amount of cottonseed flakes in the composition is about 3, 3.3, 3.5, 3.8, 4, 4.5 or 5% by weight based on the total weight of the composition.

In certain embodiments, the margarine formulations further comprise additional ingredients, such as butter flavors, meat or tallow flavors, olive oil flavors and other natural or synthetic flavors. In certain embodiments, vitamins can be included in the compositions provided herein. In certain embodiments, the compositions comprise vitamin A palmitate. In certain embodiments, various other additives can be used in the margarines provided that they are edible and aesthetically desirable.

In certain embodiments, the margarine composition provided herein comprises about 25-30% reduced trans base oil, about 25-30% soybean oil, about 35-40% water, about 3.5-4% cottonseed flakes, about 0.5-1.5% soybean hard fat, about 0.5-1.5% low sodium sea salt, one or more additives and a probiotic in an amount of at least about 1 billion colony forming units per serving of the composition.

In certain embodiments, the margarine composition provided herein comprises about 27.61% reduced trans base oil, about 27.76% soybean oil, about 38.12% water, about 3.8% cottonseed flakes, about 1.00% soybean hard fat, about 1.00% low sodium sea salt, one or more additives and a probiotic in an amount of at least about 1 billion colony forming units per serving of the composition.

In certain embodiments, the margarine composition provided herein comprises about 25-30% reduced trans base oil, about 25-30% soybean oil, about 35-40% water, about 3.5-4% cottonseed flakes, about 0.5-1.5% soybean hard fat, about 0.5-1.5% low sodium sea salt, about 0.2-0.35% distilled mono and diglycerides, about 0.1-0.3% soybean lecithin, about 0.05 to 0.15% sodium benzoate, about 0.02-0.07% lactic acid, about 0.001-0.003% beta-carotene, about 0.001-0.004% Vitamin A palmitate, about 0.05-0.08% artificial butter flavor, and a probiotic in an amount of at least about 1 billion colony forming units per serving of the composition.

In certain embodiments, the margarine composition provided herein comprises about 27.61% reduced trans base oil, about 27.76% soybean oil, about 38.12% water, about 3.8% cottonseed flakes, about 1.00% soybean hard fat, about 1.00% low sodium sea salt, about 0.29% distilled mono and diglycerides, about 0.2% soybean lecithin, about 0.1% sodium benzoate, about 0.05% lactic acid, about 0.002% beta-carotene, about 0.0028% Vitamin A palmitate, about 0.069% artificial butter flavor, and a probiotic in an amount of at least about 1 billion colony forming units per serving of the composition.

Methods of Preparation

In certain embodiments, provided herein are methods of preparing the low sodium shelf stable margarine compositions comprising probiotics. In certain embodiments, the methods of preparation comprise the steps of mixing a reduced trans base oil, an unhydrogenated oil, water, a low sodium sea salt, and one or more additives to obtain an admixture, cooling the admixture, and mixing a probiotic to provide the margarine composition. During the first mixing step, the composition is brought to a molten state such that the admixture becomes homogenized. The order of adding the ingredients and heating the ingredients can be changed as required by a particular process. The ingredients can be added at ambient temperature, or at a higher temperature, depending on the particular system used, and it is intended that the claims appended hereto shall not be limited by the order of the heating and mixing steps. The molten homogeneous composition is cooled, in one embodiment, with agitation, to promote a crystal structure that imparts the desired physical properties to the margarine. A heat exchanger, in one embodiment, a scraped surface heat exchanger, can provide the desired cooling with agitation.

In certain embodiments, the probiotic is added after the cooling step and prior to the second mixing step such that the composition is cool enough for the probiotic to survive and the probiotic is mixed thoroughly prior to the packaging of the composition. In certain embodiments, the probiotic is added to the oil phase before blending with the water phase. In certain embodiments, the probiotic is added to the oil/water blend. In certain embodiments, the probiotic is added to the water phase prior to blending with the oil phase.

In certain embodiments, the probiotic is incorporated at a temperature ranging from about 90° F.-120° F. or about from 108° F.-114° F. In certain embodiments, the probiotic is incorporated at a temperature of about 90, 95, 100, 105, 108, 110, 115 or 120° F.

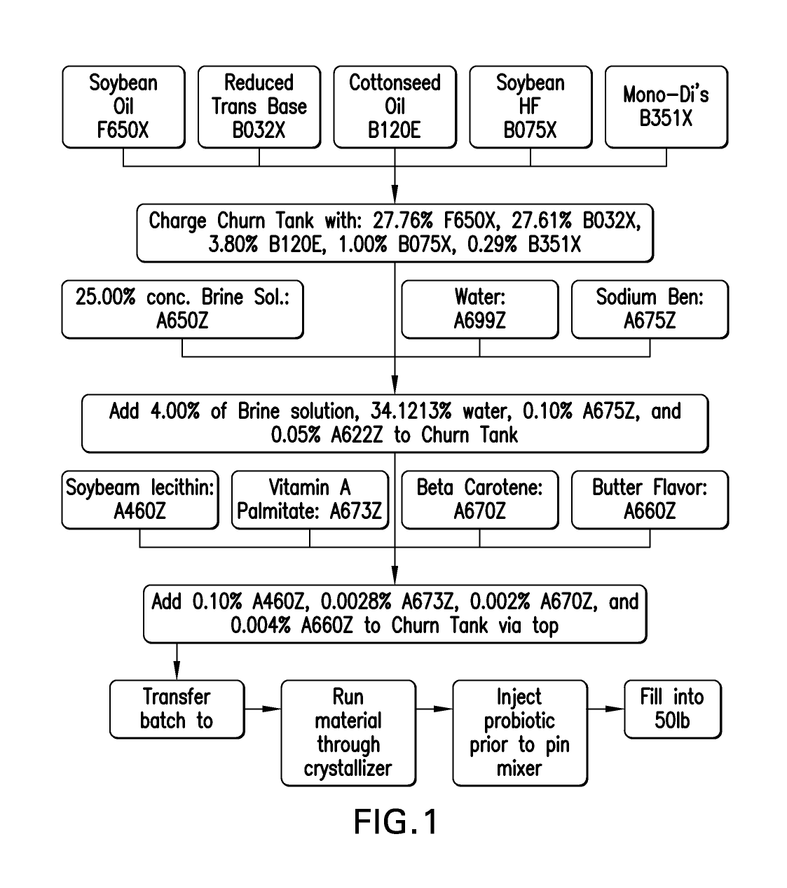

In certain embodiments, a pin mixer is used to mix the probiotic. In certain embodiments, the probiotic is added prior to mixing with the pin mixer. The final composition is cooled in, for example a crystallizer. An exemplary flow diagram showing various steps in the method is provided in FIG. 1.

The mixing of a reduced trans base oil, a vegetable oil, water, a low sodium sea salt, and one or more additives can be accomplished using techniques known in the art. In certain embodiments, the admixture can be then subjected to agitation by means of a scraped-surface heat exchanger known in the art of margarine manufacture. In certain embodiments, processing conditions within the scraped-surface heat exchanger can be adjusted to further promote the desired margarine properties. The scraper blades prevent any build-up on the cylinder of crystals and other large particulates that can reduce thermal exchange and increase run time. A number of different operating parameters in the scraped-surface heat exchanger can be modified in order to optimize the one or more properties of the margarine (e.g., hardness, melting). For example, the speed of the scraping blades, the pumping speed through the scraped surface heat exchanger, and the exit temperature from the heat exchanger can be modified to optimize the hardness of the margarine.

The margarines produced herein can be used to produce a variety of foods including, but not limited to, baked goods, an icing, biscuits, bread, a pie crust, a danish, a croissant, or a pastry puff. With the reduction in trans fat and sodium content, and addition probiotics, food products produced with the margarines described herein can provide health benefits.

The following examples present certain exemplary embodiments and are intended by way of illustration and not by way of limitation. In each of the examples herein, percentages indicate weight percent of the total mixture, unless otherwise indicated.

### EXAMPLES

The following examples are put forth so as to provide those of ordinary skill in the art with a complete disclosure and description of how the compounds, compositions, and methods described and claimed herein are made and evaluated, and are intended to be purely exemplary and are not intended to limit the scope of the claimed subject matter. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures and other reaction ranges and conditions that can be used to optimize the product purity and yield obtained from the described process. Only reasonable and routine experimentation will be required to optimize such process conditions.

### Example 1

Margarine Formulation

| Ingredient | Percentages |
|---|---|
| Reduced Trans Base Oil | 27.61% |
| Cottonseed Flakes | 3.80% |
| Distilled Mono & Diglycerides | 0.29% |
| Soybean Oil | 27.76% |
| Soybean Hardfat | 1.00% |
| Soybean Lecithin | 0.20% |
| Vitamin A Palmitate | 0.0028% |
| Beta-Carotene | 0.002% |
| Water | 38.12% |
| Low Sodium Sea Salt | 1.00% |
| Sodium Benzoate | 0.10% |
| Lactic Acid | 0.05% |
| Artificial Butter Flavor | 0.069% |

In Example 1, reduced trans base oil, unhydrogenated oil, hard fat and emulsifier were charged in a churn tank and blended together. A solution of water, low sodium sea salt, sodium benzoate and lactic acid was added to the churn tank followed by addition of additives. The blend of transferred to a holding tank and cooled by passing through a crystallizer to obtain a soft spread margarine formulation.

### Example 2

### Initial stability Study

An initial proof of concept stability study was conducted using the feasibility formulation of soft spread. Three 600 g batches of the soft spread were melted and 0.2% bifidum bacteria were added to each batch at a temperature of 110° F. Each batch was allowed to mix via a magnetic stir bar for 2-3 minutes and then crystallized in the ice cream maker. All samples were put into the freezer (−20° F.) overnight and then put into their respective temperature environments, which were 40° F., 70° F. and 85° F. Samples were pulled every 2 weeks up to duration of 10 weeks.

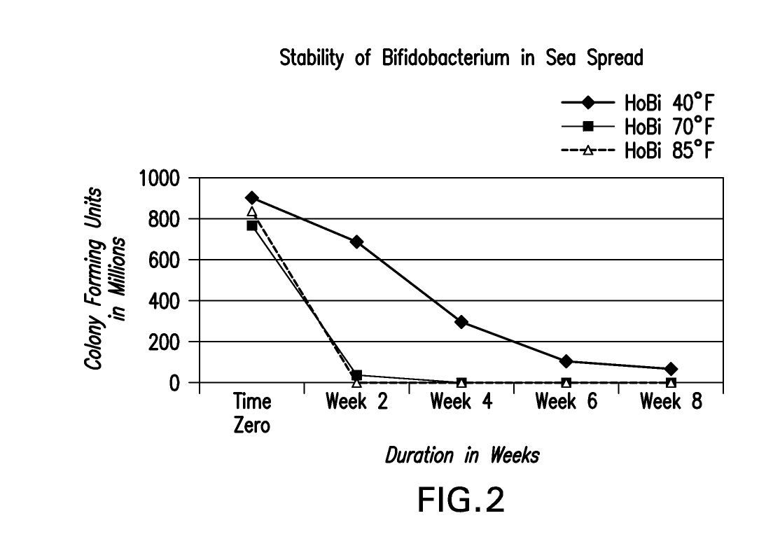

The data observed from the initial stability study is shown in Table 2 and FIG. 2.

TABLE 2
Stability of Soft Spread at a 0.2% usage level.
Soft Spread Stability in mm per gram

| | HoBi* 40° F. | HoBi* 70° F. | HoBi* 85° F. |
|---|---|---|---|
| Time Zero | 897 | 757 | 827 |
| Week 2 | 687 | 32 | 0 |
| Week 4 | 293 | 0 | 0 |
| Week 6 | 105 | 0 | 0 |
| Week 8 | 69 | 0 | 0 |
| Week 10 | 48.6 | 0 | 0 |

*HoBi = HOWARU ® bifidobacterium (Danisco - Copenhagen, Denmark)

The data showed that the bifidobacterium survived within the soft spread during the ten weeks. The recommended amount of bifidobacterium that are to be present in order to convey health benefits to the consumer are 1 billion per serving size. The stability data shown in Table 2 and in FIG. 2 display that the probiotics are stable and provide the recommended amount up to 8 week period. The samples that were stored at 70° F. and 85° F. were not successful in sustaining the necessary amount needed to pass on healthful benefits to the consumer.

### Example 3

### Temperature Tolerance Test

Four 200 g batches of soft spread were melted and 0.2% bifidum bacteria was added once the samples reached their respective temperature. The temperatures analyzed were 90° F., 98.6° F., 110° F., and 120° F. The samples were then crystallized via an ice maker and placed in the freezer overnight. Samples were sent for bifido bacterium enumeration the next day.

The data in Table 3 shows that the bacteria incorporated at temperatures ranging from 90° F.-120° F. remain fairly stable if crystallized immediately after mixing for 2 minutes.

The calculations of product inoculation were based off of approximated colony forming units present per gram; however due to the batch to batch variability of the probiotics the colony forming units may be higher at any given sampling. The approximate inoculation colony forming unit count at 0.20% usage was 600 million; the average colony forming units seen at a 0.20% usage level based upon time zero data from various studies conducted was 828.2 million.

TABLE 3
Temperature Tolerance data using 0.20% bacterium.
Temperature tolerance at 0.20% probiotic level in
MM per gram and survival percentages

| | | |
|---|---|---|
| 90.0° F. | 786.6 | 131.10% |
| 98.6° F. | 566.6 | 94.43% |
| 110.0° F. | 1,010 | 168.33% |
| 120.0° F. | 816.6 | 136.10% |

### Example 4

### Processing Temperature Test

Six 600 g batches of soft spread were melted and had bifidum bacteria added once the samples reached their respective temperatures of either 110° F. or 120° F. The samples were held at those temperatures while mixing and approximately 100g of each batch were pulled and crystallized via the ice cream maker at time zero, ½ hour, 2 hours, and 4 hours. The samples were stored in the freezer overnight and then sent for bifidobacterium enumeration the next day.

The data provided in tables 4-1, 4-2, and 4-3 show the survival rate of bifidobacterium when processed at both 110° F. and 120° F. for an extended amount of time.

Table 4-1 provides data using bifidobacterium at a 0.15%. The bacteria have a higher survival rate at 110° F., at 120° F., a low survival rate was observed.

TABLE 4-1
Processing temperature data using 0.15% bacterium
Processing Temperature Tolerance at 0.15% Probiotic
Level in MM per gram and Survival Percentages

| | |
|---|---|
| 110° F. | 120° F. |

| Time Zero | | 350.00 | 77.77% | 2.00 | 0.44% |
|---|---|---|---|---|---|
| ½ | Hour | 270.00 | 60.00% | 1.00 | 0.22% |
| 2 | Hour | 7.00 | 1.56% | 1.00 | 0.22% |
| 4 | Hour | 1.00 | 0.22% | 1.00 | 0.22% |

Table 4-2 provides data for the processing temperature at 110° F., with an increased amount of bifidobacterium (0.25%) in order to compensate for any loss during processing as well as to maintain the recommended intake amount of at least 1 billion per serving. The data show that the bacterium withstands the recommended amount up to the 2 hours.

TABLE 4-2
Processing temperature data using 0.25% bacterium
Processing Temperature Tolerance at 0.25% Probiotic Level

110° F.

| Time Zero | | 1,300,000,000 | 173.33% |
|---|---|---|---|
| ½ | Hour | 1,400,000,000 | 186.67% |
| 2 | Hour | 1,200,000,000 | 160.00% |

Due to the excellent survival rates of the 0.25% usage level of bacterium, the amount was decreased to 0.2% to ensure not to over inoculate the product. Table 4-3 provides data using 0.20% of bacterium. The data follows the overall trend of gradual decline in bacterium present when held at 110° F. for up to 4 hours. However a sharp decline was observed in the 4th hour pull. Without being bound to any particular theory, it is believed that the decline was due to an increase in temperature past 110° F. Since the study was conducted lab scale, magnetic stir bars were used which were not able to keep the complete blend product moving to avoid the setting up of product which in turn required additional heat to be applied to re-melt. This issue was not observed with the oil phase and aqueous phases

TABLE 4-3
Processing temperature data using 0.20% bacterium
110° F. Processing Temperature Tolerance at 0.20%
Probiotic Level in MM per gram and Survival Percentages

| | Complete Blend | | Oil Phase | | Aqueous Phase | |
|---|---|---|---|---|---|---|
| Time Zero | 540 | 90.00% | 556.6 | 92.76% | 1,100 | 183.33% |
| ½ Hour | 653.3 | 108.88% | 383.3 | 63.88% | 1,000 | 166.66% |
| 2 Hour | 363.3 | 60.55% | 380 | 63.33% | 903.3 | 150.55% |
| 4 Hour | 12.30 | 2.05% | 433.3 | 72.21% | 813.3 | 135.55% |

The data has shown in tables 4-1, 4-2, and 4-3 indicates that the bacteria can withstand the temperature of 110° F. for extended time periods.

### Example 5

### Phase Incorporation Stability Study

A phase incorporation stability was conducted in which three 500 g batches of soft spread were prepared and 0.2% bifidum bacteria incorporated at different phases. The different phases consisted of i) bifidobacterium added once the oil and aqueous phases were combined prior to votation, ii) bifidobacterium added in the oil phase, and iii) bifidobacterium added in the aqueous phase. The complete blend samples were crystallized after the addition of bifidobacterium and then placed in the 40° F. environment. Samples were pulled every 2 weeks up to the 8th week.

The data shown in table 5 represent the shelf life stability of the bacterium when the bacterium was added at different stages of production. The complete blend represents the bacterium being added as the final ingredient to the soft spread; the other two incorporations phases represent the bacterium being added either at the oil or aqueous phase.

TABLE 5
Phase Incorporation Stability Study Data using 0.2% bacterium.
Soft Spread Phase Incorporation Stability Data in
MM per gram and Survival Percentages

| | Complete Blend | | Oil Phase | | Aqueous Phase | |
|---|---|---|---|---|---|---|
| Time Zero | 1,500 | 250.00% | 816 | 125.54% | 596 | 91.69% |
| Week 2 | 376.6 | 57.94% | 573.3 | 88.20% | 180 | 27.69% |
| Week 4 | 37.3 | 5.74% | 463.3 | 71.28% | 790 | 121.54% |

The data show that the bacterium is more stable upon being added in the oil phase; however other data from other tests have shown that addition of bacterium in the complete blend is also stable. Thus incorporation of bacterium in either the oil phase or complete blend is acceptable.

### Example 6

### Pilot Plant Run Stability Study

A pilot batch of soft spread was produced were the probiotic was added as the final ingredient. The bifidobacterium were added to the product once the oil and water phases were combined at a 0.2% usage level. Samples were pulled from 15 lb cubes every 2 weeks up to the 10th week.

The optimal processing temperature was found to be 110° F.; the optimum range was 108° F. to 114° F. Additionally, mixing of the product required enough agitation to keep the product moving so that it does not set up. The free-wheeling speed of the agitators used via pilot plant trial were 1,530 rpm with a 4″ mixed flow impeller and 715 rpm with a 8″ 4 blade hydro foil impeller. The rpm's noted did not include the resistance given by the product

### Example 7

### Application Survival Study

The functionality of the Bifidobacteria was tested upon being spread onto a warm surface such as toast, bagels, and English muffins. The three different brands of the most commonly used toasters that were used to prepare the samples were Kitchen aid KMTT2000, Proctor-Silex®, and Oster Counterforms 6335®. The temperature of the toast, bagels, and English muffins were observed 4 times for each application time interval; and the temperature was observed for three different toasters. This allowed us to identify the average temperature of the food item at a given time interval. The time intervals that were observed were time zero, 30 seconds, 1, 2, and 5 minutes. The soft spread was then be spread onto the food items at there appropriate time interval which represents a given temperature. Each sample had 7 g of spread applied to the food item. The samples were then placed in the freezer and submitted for bifidobacterium enumeration.

The application survival study data shown below in tables 6-1, 6-2, and 6-3 represents the survival rate of bacterium in the spread upon typical consumer use.

TABLE 6-1
Application Survival Study using Oster Counterforms 6335 ® toaster.
Oster Counterforms 6335 ® Toaster Bifido Data in
MM per gram and Survival Percentages

| Sample | Zero | | 30 Sec | | 1 min | | 2 min | | 5 min | |
|---|---|---|---|---|---|---|---|---|---|---|
| Toast | 105 | 35.00% | 177 | 59.00% | 123 | 41.00% | 171.9 | 57.30% | 193.8 | 64.60% |
| Bagels | 246.9 | 82.30% | 93 | 31.00% | 183.9 | 61.30% | 156.9 | 52.30% | 304.8 | 101.60% |
| English | 264 | 88.00% | 255.9 | 85.30% | 189.9 | 63.30% | 153 | 51.00% | 294 | 98.00% |
| Muffins | | | | | | | | | | |

TABLE 6-2
Application Survival Study using Kitchen aid KMTT200 ® toaster.
Kitchen aid KMTT200 ® Toaster Bifido Data in
MM per gram and Survival Percentages

| Sample | Zero | | 30 Sec | | 1 min | | 2 min | | 5 min | |
|---|---|---|---|---|---|---|---|---|---|---|
| Toast | 117 | 39.00% | 214.8 | 71.60% | 177.9 | 59.30% | 214.8 | 71.60% | 297 | 99.00% |
| Bagels | 73.8 | 24.60% | 154.8 | 51.60% | 106.8 | 35.60% | 138.9 | 46.30% | 214.8 | 71.60% |
| English | 138 | 46.00% | 246 | 82.00% | 183.9 | 61.30% | 154.8 | 51.60% | 399.9 | 133.30% |
| Muffins | | | | | | | | | | |

TABLE 6-3
Application Survival Study using Proctor-Silex ® toaster
Proctor-Silex ® Toaster Bifido Data in
MM per gram and Survival Percentages

| Sample | Zero | | 30 Sec | | 1 min | | 2 min | | 5 min | |
|---|---|---|---|---|---|---|---|---|---|---|
| Toast | 219.9 | 73.30% | 207.9 | 69.30% | 298.8 | 99.60% | 469.8 | 156.60% | 288.9 | 96.30% |
| Bagels | 208.8 | 69.60% | 258.9 | 86.30% | 177 | 59.00% | 186 | 62.00% | 264 | 88.00% |
| English | 10.59 | 3.53% | 9.48 | 3.16% | 10.38 | 3.46% | 10.29 | 3.43% | 78.9 | 26.30% |
| Muffins | | | | | | | | | | |

The overall trend observed showed that the bacterium had a higher survival rate upon allowing the food item to cool briefly prior to spread application. The outliers present within the tables may be attributed to laboratory error.

The data shown in tables 6-4, 6-5, and 6-6 represent the average temperature of the food item as its respective time interval.

TABLE 6-4
Average Temperatures of Food Items
using Oster Counterforms 6335 ® toaster.
Oster Counterforms 6335 ® Toaster Data
Average Temperatures of Food Items

| Sample | Zero | 30 Sec | 1 min | 2 min | 5 min |
|---|---|---|---|---|---|
| Toast | 210.1° F. | 148.0° F. | 138.4° F. | 116.2° F. | 91.8° F. |
| Bagels | 190.6° F. | 144.3° F. | 144.8° F. | 131.8° F. | 103.6° F. |
| English | 224.1° F. | 184.2° F. | 165.8° F. | 143.6° F. | 114.1° F. |
| Muffins | | | | | |

TABLE 6-5
Average Temperatures of Food Items
using Kitchen aid KMTT200 ® toaster
Kitchen aid KMTT200 ® Toaster Data
Average Temperatures of Food Items

| Sample | Zero | 30 Sec | 1 min | 2 min | 5 min |
|---|---|---|---|---|---|
| Toast | 225.3° F. | 155.7° F. | 134.1° F. | 113.8° F. | 88.9° F. |
| Bagels | 222.4° F. | 160.5° F. | 139.1° F. | 130.8° F. | 103.9° F. |
| English | 241.4° F. | 180.4° F. | 160.9° F. | 141.3° F. | 111.7° F. |
| Muffins | | | | | |

TABLE 6-6
Average Temperatures of Food Items
using Proctor-Silex ® toaster
Proctor-Silex ® Toaster Data Average
Temperatures of Food Items

| Sample | Zero | 30 Sec | 1 min | 2 min | 5 min |
|---|---|---|---|---|---|
| Toast | 218.9° F. | 154.5° F. | 136.0° F. | 115.9° F. | 91.1° F. |
| Bagels | 233.0° F. | 169.8° F. | 159.9° F. | 136.9° F. | 112.1° F. |
| English | 224.9° F. | 184.5° F. | 165.1° F. | 144.2° F. | 112.3° F. |
| Muffins | | | | | |

The data shown in tables 6-1 through 6-6 provide a direct correlation between the increase in survival rate based upon a typical temperature of a given food item.

### Example 7

### Environmental Stress

Approximately 150 grams of soft spread was dispensed into twelve 4 oz plastic containers. Six containers each were placed at 70° F. and 85° F. in order to simulate a consumer leaving the soft spread out of a refrigerated environment for up to 6 hours. Samples were pulled at the following timeframes: ½, 1, 1½, 2, 4, and 6 hours. The samples were submitted for bifidobacterium enumeration to observe the survival of probiotics when in a stressed environment such as ambient or slightly above ambient temperatures.

Table 7-1 provides data for probiotics in each sample.

TABLE 7-1
Environmental stress stability of soft spread with
probiotics added as final ingredient at a 0.2% usage level.
Environmental Stress Data at 0.20% Probiotic Level in
MM per gram and Survival Percentages

| | |
|---|---|
| 70° F. | 85° F. |

| Time Zero | | 606.6 | 101.10% | 606.6 | 101.10% |
|---|---|---|---|---|---|
| ½ | Hour | 563.3 | 93.88% | 410 | 68.33% |
| 1 | Hour | 373.3 | 62.22% | 780 | 130.00% |
| 1½ | Hour | 580 | 96.66% | 366.6 | 61.10% |
| 2 | Hour | 790 | 131.66% | 630 | 105.00% |
| 4 | Hour | 490 | 81.66% | 713.3 | 118.88% |
| 6 | Hour | 460 | 76.66% | 646.6 | 107.76% |

Data in Table 7-1 shows that the probiotics in the soft spread are stable and can withstand the environmental stress of being left out of the 40° F. environment thus being able to continue to provide the healthful benefit to the consumer.

### Example 8

### Sensory (Triangle) Panel

A hot triangle panel was conducted comparing the soft spread to the soft spread with probiotics added. The triangle panel was conducted using freshly prepared biscuits; only the tops were used in the panel to avoid any browning off-notes that may be present from the bottom of the biscuit. The biscuit tops had 7g of spread applied to them. At a significance level of 95%, the soft spread with probiotics did not have a significant difference from the soft spread without probiotics.

### Example 9

### Pilot Plant Final Ingredient Stability Study

The bifido bacteria were added to the product once the oil and water phases were combined at a 0.2% usage level. Samples were pulled from 15 lb cubes every 2 weeks up to the 10th week.

The stability data is provided in table 9-1.

TABLE 9-1
Stability of soft spread with probiotics
added as final ingredient at a 0.2% usage level
Pilot Plant Sea Spread Probiotics Final
Addition Stability in MM per gram

Sea Spread Pilot

| | | |
|---|---|---|
| Time Zero | 305.4 | 50.90% |
| Four Day | 916.6 | 152.77% |
| Week 2 | 713.3 | 118.88% |
| Week 4 | 87.7 | 14.62% |
| Week 6 | 190 | 31.67% |
| Week 8 | 0.000263 | N/A |

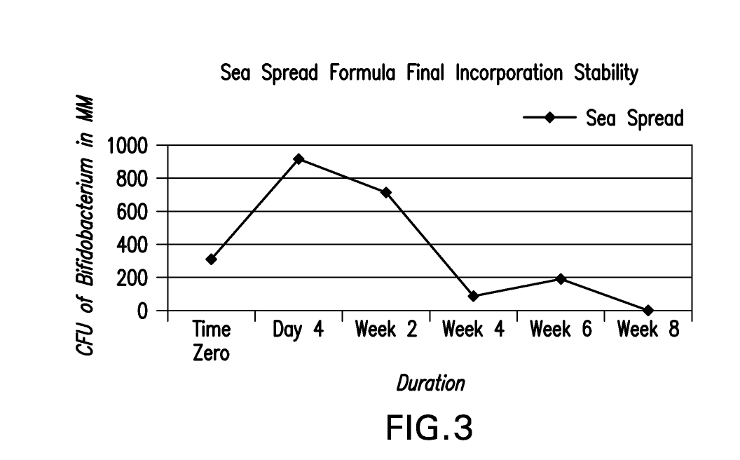

The stability data shown above in table 9-1 and in FIG. 3 display that the probiotics are stable when incorporated as the final ingredient and provide the recommended amount of probiotics needed to convey health benefits up to the 6 week period.

### Example 10

### Pilot Plant Phase Incorporation Stability Study

The data observed from the initial stability study showed that the bifidobacterium survive within the soft spread during ten weeks of storage at 40° F. To investigate the possible advantages and disadvantages of incorporating probiotics at different phases during processing a pilot plant batch was produced in which probiotics were added in the oil and water phase.

The stability data is shown below in table 10-1.

TABLE 10-1
Stability of soft spread with probiotics
added in oil & water phases at a 0.2% usage level.
Sea Spread Pilot Plant Phase Incorporation
Stability in MM per Gram

| | |
|---|---|
| Oil Phase | Water Phase |

| | | | | |
|---|---|---|---|---|
| Time Zero | 130 | 21.67% | 575 | 95.83% |
| Week 2 | 6 | 1.00% | 640 | 106.67% |
| Week 4 | 5.6 | 0.93% | 470 | 78.33% |
| Week 6 | 11 | 1.83% | 440 | 73.33% |
| Week 8 | 8.6 | 1.43% | 520 | 86.67% |
| Week 10 | 2.5 | 0.42% | 370 | 61.67% |
| Week 12 | N/A | N/A | 390 | 65.00% |
| Week 14 | N/A | N/A | 240 | 40.00% |

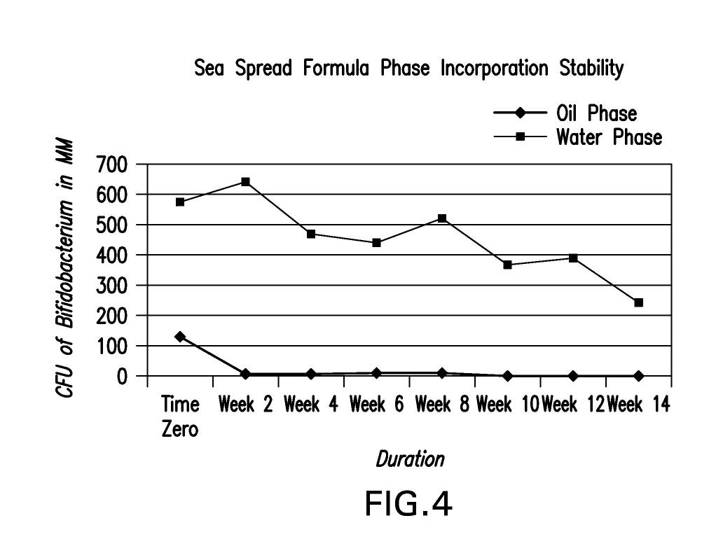

The stability data shown in table 10-1 and in FIG. 4 display that the probiotics are more stable when incorporated in the water phase and provide the recommended amount of probiotics needed to convey health benefits up to the 14 week period.

Throughout this application, various publications are referenced. The disclosures of these publications in their entireties are hereby incorporated by reference into this application in order to more fully describe the compounds, compositions and methods described herein.

Various modifications and variations can be made to the compounds, compositions and methods described herein. Other aspects of the compounds, compositions and methods described herein will be apparent from consideration of the specification and practice of the compounds, compositions and methods disclosed herein. It is intended that the specification and examples be considered as exemplary.

What is claimed is:

1. A composition comprising a reduced trans base oil, an unhydrogenated oil, water, a low sodium sea salt, a probiotic and one or more additives.

2. The composition of claim 1, wherein the margarine has a shelf life of up to 6-8 weeks.

3. The composition of claim 1, wherein the probiotic is selected from Lactobacillus bulgaricus, Lactobacillus casei, Lactobacillus acidophilus, Lactococcus lactis, Streptococcus thermophilus, Bifidobacterium bifidum, Bifidobacterium lingum and a mixture thereof.

4. The composition of claim 1, wherein the probiotic is Bifidobacterium bifidum.

5. The composition of claim 1, wherein the level of probiotic in the composition is at least about 1 billion colony forming units per serving of the composition.

6. The composition of claim 1, wherein the composition contains about 0.5%, 1%, 1.5% or 2% low sodium sea salt is present based on the total amount of the composition.

7. The composition of claim 1, wherein the composition contains about 20% to about 35% reduced trans base oil based on the total amount of the composition

8. The composition of claim 1, wherein the unhydrogenated oil comprises canola oil, high oleic canola oil, soybean oil, corn oil, sunflower oil, rapeseed oil, peanut oil, safflower oil, olive oil, cottonseed oil, or a mixture thereof.

9. The composition of claim 1, wherein the unhydrogenated oil comprises soybean oil.

10. The composition of claim 1, wherein the composition contains about 20-40% unhydrogenated oil by weight based on total weight of the composition.

11. The composition of claim 1 further comprising a hard fat.

12. The composition of claim 11, wherein the hard fat comprises a fully or partially hydrogenated oil, solid stearin fraction, diglyceride, monoglyceride, wax or a mixture thereof.

13. The composition of claim 11, wherein the hard fat comprises soybean oil hard fat.

14. The composition of claim 11, wherein the composition contains about 0.5 to about 2% hard fat by weight based on total weight of the composition.

15. The composition of claim 1, wherein the composition contains about 30-45% water by weight based on the total weight of the composition.

16. The composition of claim 1, wherein the additive is selected from a stabilizer, a flavoring agent, an emulsifier, an anti-spattering agent, a colorant, an antioxidant and a mixture thereof.

17. The composition of claim 1 comprising about 25-30% reduced trans base oil, about 25-30% soybean oil, about 35-40% water, about 3.5-4% cottonseed flakes, about 0.5-1.5% soybean hard fat, about 0.5-1.5% low sodium sea salt, about 0.2-0.35% distilled mono and diglycerides, about 0.1-0.3% soybean lecithin, about 0.05 to 0.15% sodium benzoate, about 0.02-0.07% lactic acid, about 0.001-0.003% beta-carotene, about 0.001-0.004% Vitamin A palmitate, about 0.05-0.08% artificial butter flavor and a probiotic in an amount of at least about 1 billion colony forming units per serving of the composition.

18. A food product comprising the margarine of claim 1.

19. A method of preparing a shelf stable low sodium margarine, wherein the method comprises the steps of
mixing a reduced trans base oil, an unhydrogenated oil, water, a low sodium sea salt, and one or more additives to obtain an admixture, cooling the admixture, and mixing a probiotic to provide the composition.

20. The method of claim 19, wherein the probiotic is incorporated at a temperature ranging from about 108° F.-114° F.

21. The method of claim 19, wherein the probiotic is incorporated at a temperature of about 110° F.
